(19) United States
(12) Patent Application Publication
(10) Pub. No.: US 2003/0063009 A1
(43) Pub. Date: Apr. 3, 2003

(54) Indicator for a lock

(75) Inventors: Thomas Pelletier, Wallingford, CT (US); John Howard, Woodbury, CT (US); Gary van Deursen, Avon, CT (US); Richard Davidian, Avon, CT (US)

Correspondence Address: PILLSBURY WINTHROP, LLP, P.O. BOX 10500, MCLEAN, VA, 22102, US

(73) Assignee: THE STANLEY WORKS, New Britain, CT (US)

(21) Appl. No.: 09/969,108

(22) Filed: Oct. 3, 2001

(51) Int. Cl. E05B 45/06

(52) U.S. Cl. 340/686.1

(57) ABSTRACT

An indicating device that may be used with a lock mechanism positioned within a door that locks and unlocks the door. The indicating device may be incorporated into a removable housing such as a trim housing. A lock portion accessible to a user may extend through the trim housing and be coupled to the lock mechanism to change the lock mechanism between a locked position and an unlocked position. A switch may be coupled to at least one of the lock mechanism and the lock portion, as well as electrically coupled to a power source and to an indicator. The switch can then selectively activate the indicator to display to a user whether the door is locked or unlocked depending on the position of the at least one of the lock mechanism and the lock portion.

### FIELD OF THE INVENTION

The present invention relates in general to indicators. In particular, the present invention relates to indicators for lock mechanisms.

### BACKGROUND OF THE INVENTION

It is known to use certain devices to indicate when a door is locked or unlocked. These devices, however, are bulky to the extent that when they are incorporated into a door lock, they do not look like ordinary doorknobs or ordinary door locks. Also, these devices are difficult to install, and once installed, the interior mechanisms of these devices are difficult to access if a repair is needed. Examples of prior art devices are found in U.S. Pat Nos. 4,683,741 to Fields; 4,760,380 to Quennevill et al.; and 5,611,226 to Fata, which are incorporated herein by reference thereto.

One embodiment of the present invention provides a door lock assembly comprising a lock mechanism configured and arranged to be positioned within a door for locking and unlocking the door; a trim housing constructed and arranged to be releasably and fixedly secured to the door; a lock portion extending through the trim housing and coupled to the lock mechanism to change the lock mechanism between a locked position and an unlocked position; an indicator affixed to the trim housing; a power source affixed to the trim housing to be releasably and fixedly secured to the door along with the trim housing; and a switch coupled to at least one of the lock mechanism and the lock portion, the switch also being electrically coupled to the power source and to the indicator, the switch being constructed and arranged to selectively activate the indicator to display to a user whether the door is locked or unlocked depending on the position of the at least one of the lock mechanism and the lock portion.

The embodiment further provides a door and lock assembly comprising a lock mechanism positioned within a door for locking and unlocking the door; a trim housing releasably and fixedly secured to an outer surface of the door such that the trim housing is positioned outside the door adjacent the outer surface of the door; a lock portion extending through the trim housing and coupled to the lock mechanism to change the lock mechanism between a locked position and an unlocked position; an indicator affixed to the trim housing; a power source affixed to the trim housing to be releasably and fixedly secured to the door along with the trim housing; and a switch coupled to at least one of the lock mechanism and the lock portion, the switch also being electrically coupled to the power source and to the indicator, the switch being constructed and arranged to selectively activate the indicator to display to a user whether the door is locked or unlocked depending on the position of the at least one of the lock mechanism and the lock portion.

The embodiment further provides door lock assembly comprising a lock mechanism configured and arranged to be positioned within a door for locking and unlocking the door; a mounting structure constructed and arranged to be fixedly secured to the door, the mounting structure having a first fastening element; a trim housing releasably and fixedly secured to the mounting structure, the trim housing having second fastening element releasably secured to the first fastening element such that the trim housing can be moved in a first direction relative to the mounting structure to fixedly secure the trim housing to the mounting structure and the trim housing can be moved in a second direction relative to the mounting structure to release the trim housing from the mounting structure; a lock portion extending through the trim housing and configured and arranged to be coupled to the lock mechanism to change the lock mechanism between a locked position and an unlocked position; and an indicator assembly coupled to the trim housing to display to a user whether the door is locked or unlocked.

The embodiment further provides door and lock assembly comprising a lock mechanism positioned within a door for locking and unlocking the door; a mounting structure fixedly secured to the door, the mounting structure having a first fastening element; a trim housing releasably and fixedly secured to the mounting structure, the trim housing having second fastening element releasably secured to the first fastening element such that the trim housing can be moved in a first direction relative to the mounting structure to fixedly secure the trim housing to the mounting structure and the trim housing can be moved in a second direction relative to the mounting structure to release the trim housing from the mounting structure; a lock portion extending through the trim housing and coupled to the lock mechanism to change the lock mechanism between a locked position and an unlocked position; and an indicator assembly coupled to the trim housing to display to a user whether the door is locked or unlocked.

The embodiment further provides a method of replacing a power source in a door lock, comprising providing a door lock attached to a door and the door lock having a removable portion, the removable portion having a first removable element; removing the removable portion from the door without the use of tools; removing the first removable element from the removable portion; attaching a second removable element to the removable portion; and reattaching the removable portion to the door without the use of tools.

Other objects, features, and advantages of the present invention will become apparent from the following detailed description of preferred embodiments, the accompanying drawings, and the appended claims

### BRIEF DESCRIPTION OF THE DRAWINGS

In the drawings, like reference numerals represent similar parts of the illustrated embodiments of the present invention throughout the several views and wherein:

FIG. 1 is an exploded, perspective view of an embodiment of a door lock assembly;

FIG. 2 is another exploded, perspective view of the embodiment of FIG. 1;

FIG. 3 is a perspective view the door lock assembly of FIG. 1, wherein a trim housing of the door lock assembly is detached from a portion of the door lock assembly;

FIG. 4 is similar to FIG. 3, but illustrates the trim housing being moved toward the door for installation;

FIG. 5 is similar to FIG. 3, but illustrates the trim housing releasably and fixedly mounted to the door;

FIG. 6 is a perspective view of the embodiment of an assembled trim housing of FIG. FIG. 7 is an exploded perspective view of the trim housing of FIG. 6;

FIG. 8 is another perspective view of the trim housing of FIG. 6;

FIG. 9 is an exploded, perspective view of the trim housing of FIG. 8;

FIG. 10 is a cross-sectional view of the door lock assembly taken along line 10-10 of FIG. 5; and

FIG. 11 is an exploded, perspective view of an embodiment of a door lock assembly arranged on the opposite side of the door as the embodiment of FIG. 1.

### DETAILED DESCRIPTION

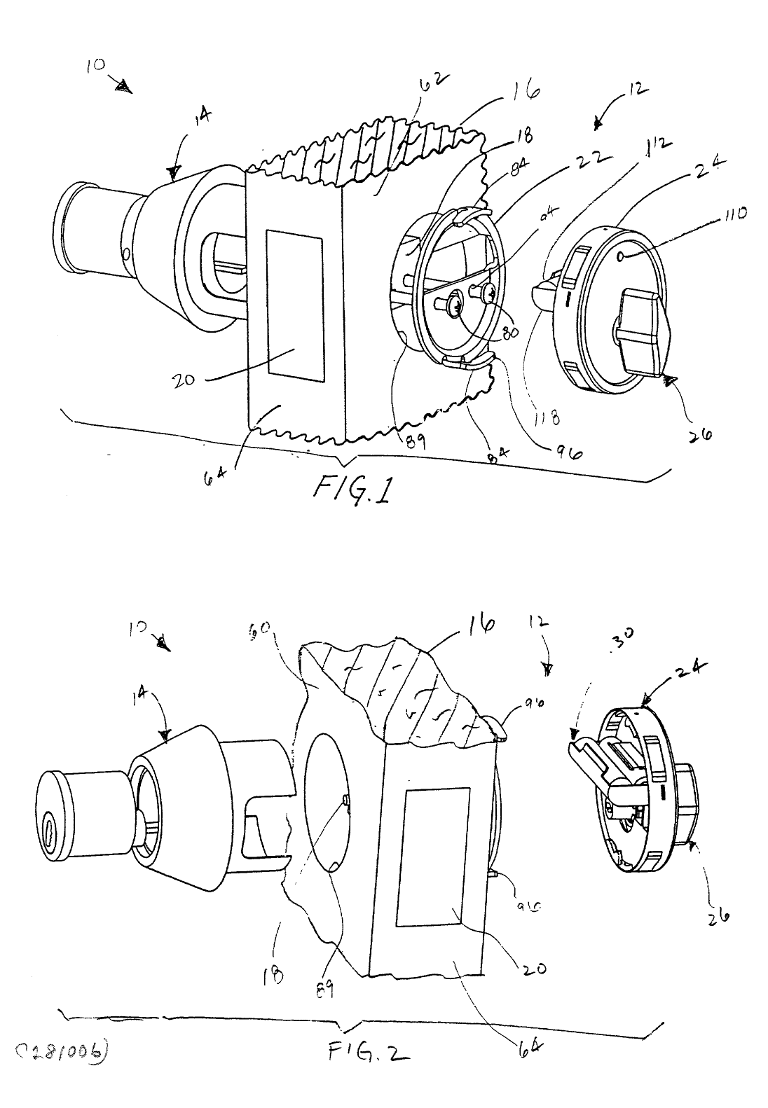

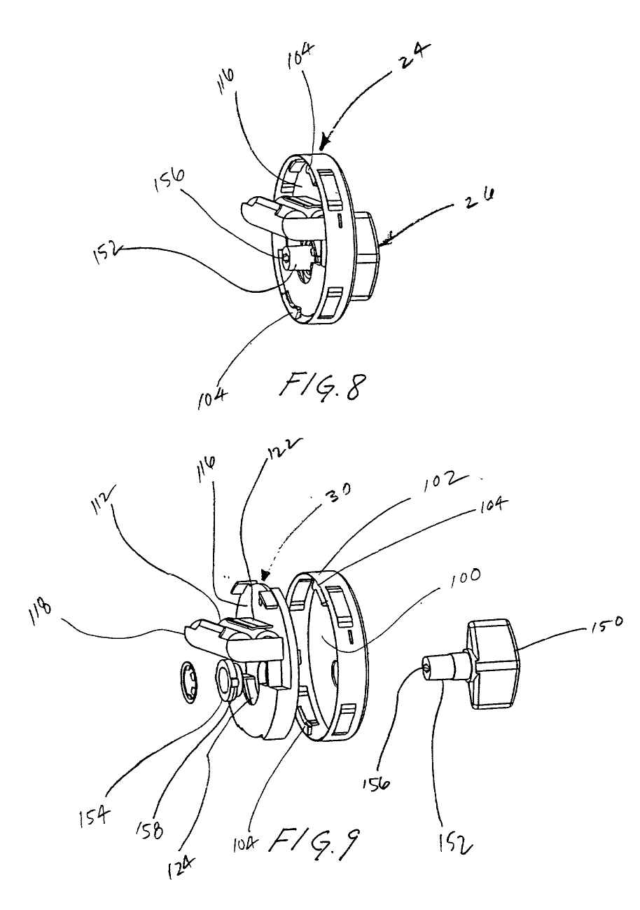

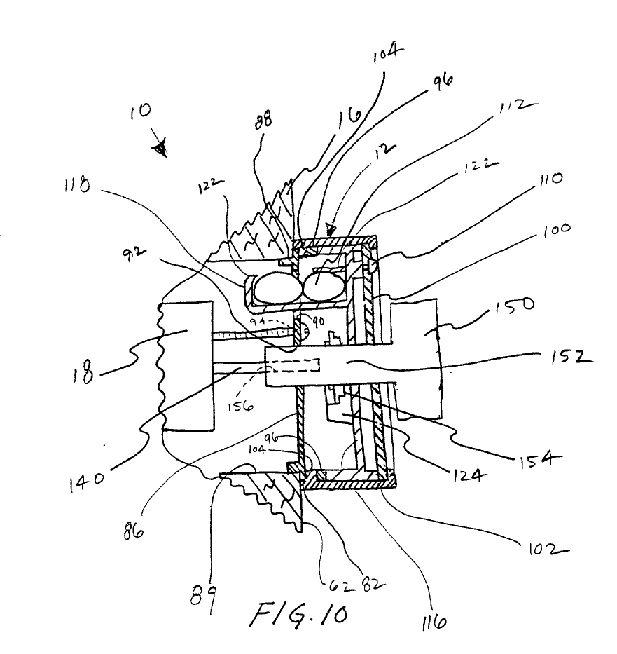

The embodiment illustrated in FIGS. 1-10 illustrates an improved indicating device and method for determining the position of a switch, such as a door lock, wherein part of the switch or lock is hidden from the view of the operator. The indicating device can include an indicator that provides a signal, such as a visual signal, informing the operator of the position of the switch or lock in order to facilitate the use of the switch or lock. For example, the operator can, through the use of the indicating device, determine the position of the switch or lock from a distance, without actually manipulating the switch or lock to determine its position.

Additionally, the illustrated embodiment illustrates an indicating device that can be constructed and arranged to provide its own power source that, if needed, can be easily replaced. Further, the indicating device can comprise a single element that can include an indicator, a power source, and the interconnection between the indicator and power source so that a single, compact device can be removably coupled to the switch so that the indicating device provides for easy replacement of parts such as the power source, when needed.

Further, the illustrated embodiment shows an indicating device that is compactly constructed so that the device can resemble other non-indicating devices that are attached to the same type of switch or lock, while maintaining the indicating abilities. The example illustrated in the figures is a thumb-turn trim housing 24 for a door lock. The trim housing 24 illustrated is sufficiently compact to give the appearance of a non-indicating trim housing so that the aesthetics of the door lock are maintained, yet the trim housing 24 provides an indication of the position of the door lock to facilitate its use.

The illustrated embodiment seen in FIGS. 1-10 shows an indicating device as discussed above included as a portion of a door lock assembly 10, wherein a trim housing 24 includes an indicator 110 and a power source 112 and is replaceably attached to both the door 16 and a lock mechanism 18 so that the elements of the trim housing 24, such as the power source 112, can be accessed. Since the power source 112, indicator 110, and other elements of the trim housing 24 are compactly configured and attached to the trim housing 24, the trim housing 24 can maintain an attractive appearance and can be easily handled, if desired.

The door lock assembly 10 as illustrated, comprises the lock mechanism 18, which is configured and arranged to be positioned within the door 16 for locking and unlocking the door 16. The assembly 10 includes the trim housing 24, such as a thumb-turn trim housing, constructed and arranged to be releasably and fixedly secured to the door 16. A lock portion 26 extends through the trim housing 24 and is coupled to the lock mechanism 18 to change the lock mechanism 18 between a locked position and an unlocked position. The indicator 110 and the power source 112 are affixed to the trim housing 24 so that they can be releasably and fixedly secured to the door 16 along with the trim housing 24. A switch 114 is coupled to at least one of the lock mechanism 18 and the lock portion 26. The switch 114 is also electrically coupled to the power source 112 and to the indicator 110, the switch 114 is constructed and arranged to selectively activate the indicator 110 to display to a user whether the door 16 is locked or unlocked depending on the position of the at least one of the lock mechanism 18 and the lock portion 26.

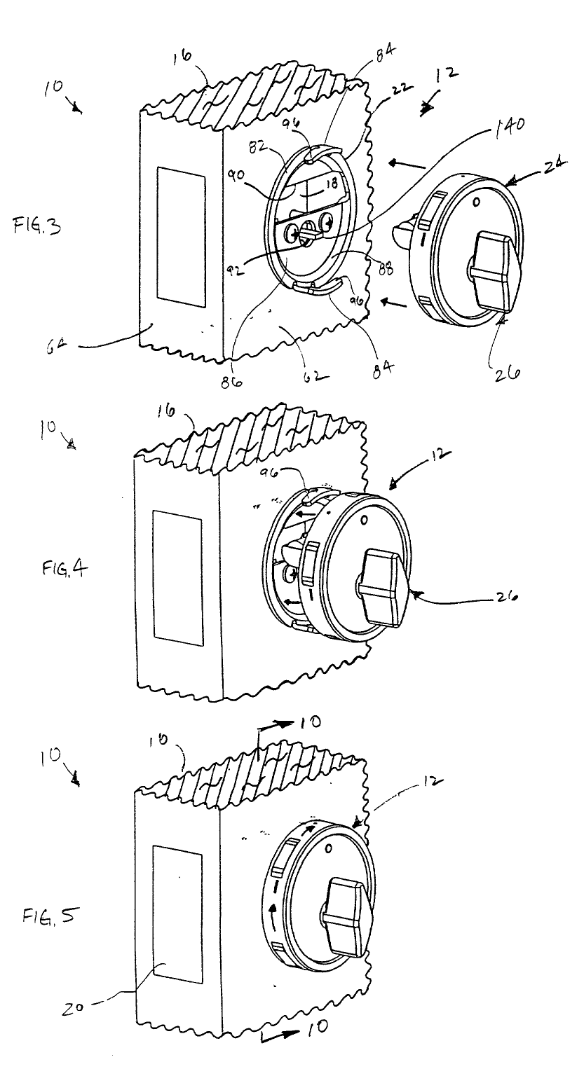

Although various configurations are possible, as seen in FIGS. 1 and 2, the illustrated embodiment illustrates the door lock assembly 10 with an inner lock section 12 and an outer lock section 14 attached to opposite sides of the door 16. The lock mechanism 18 extends within door 16 and is capable of being coupled on either side of the door as with conventional lock mechanisms and functions to lock a door as with conventional lock mechanisms. Lock mechanism 16 includes a lock bolt 20 that that is moved between an open or retracted position within door 16 as seen in FIG. 1, and a closed or extended position (not seen) in which bolt 20 projects from door 16 and extends into a door frame (not seen) on which the door is hung. The bolt 20 and its attachment to the door 16 and its movement within the door 16 may be of conventional construction.

Door 16 may be any door on which a lock is needed or desired. Door 16 illustrated herein has an outside surface 60, an inside surface 62, and a door frame edge 64 that may be flush with the door frame when door 16 is in the closed position.

The outer lock section 14 is optionally coupled to lock mechanism 18 to provide access to the lock mechanism 18 from the side of the door 60 that is opposite to the side of the door 62 on which inner lock section 12 is attached. Of course, if access on the outer door side 60 is not desired, lock section 14 can be omitted. If employed, lock section 14 can be any type of lock section that provides the desired access to the lock mechanism 18. For example, as illustrated in FIGS. 1 and 2, the lock section 14 can be a key-entry lock section such as those found on the outside surface of exterior doors.

The inner lock section 12 includes a mounting structure 22 and a housing 24, which is illustrated in the figures as a trim housing. The mounting structure 22 can take a various forms in achieving its function of providing a releasable coupling between the door 16 and the housing 24. The mounting structure 22 necessarily needs to be substantially rigidly attached to the door 16, while having appropriate fastening elements 84 such that housing 24 can be releasably attached to the mounting structure 22 and, thus, be releasably attached to the door 16. Alternatively, mounting structure 22 could be eliminated altogether if housing 24 is configured to directly attach in a releasable manner with door 16 and/or with lock mechanism 18. A desirable feature is to provide a mechanism by which housing 24 can be releasably attached to the lock mechanism 18.

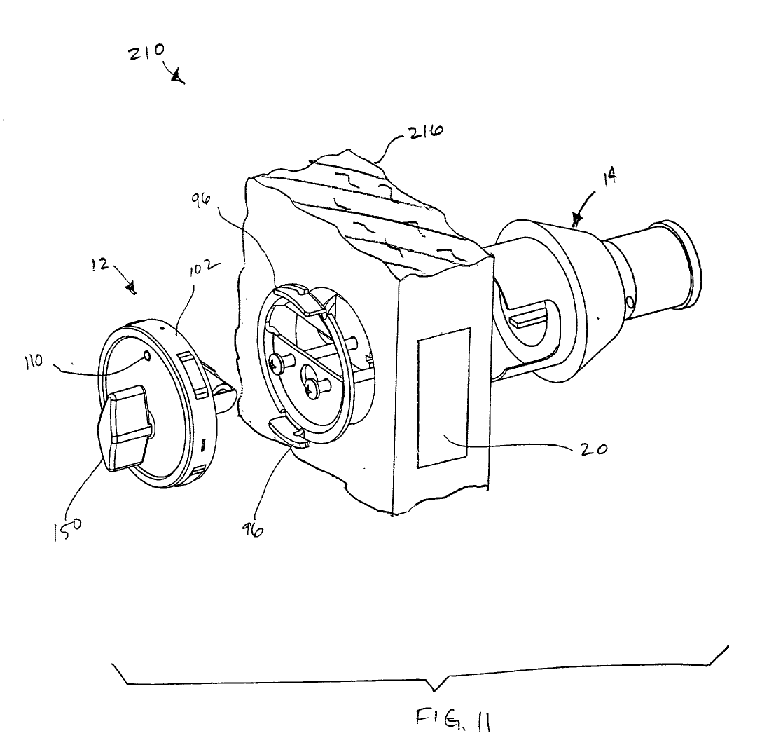

In FIGS. 1 and 10, the embodiment utilizes mounting structure 18 in the form of a plate. Plate 22 is a substantially rigid plate that may be fastened to the lock mechanism 18 positioned within door 16 in a convention manner. As seen in FIG. 1, plate 22 may be mounted to lock mechanism 18 by fasteners, such as screws 80.

Plate 22 may take various forms. In the illustrated embodiment in FIGS. 1 and 10, plate 22 includes an outer ring 82 having fastening elements 84 for attaching to housing 24. A substantially planar, recessed base 86 is positioned within the outer ring 82 and forms an annular ledge 88 in its connection with ring 82. Ledge 88 fits within an opening 89 in door 16 to position plate 22 within door 16. Plate 22 also has as power source opening 90, a lock portion opening 92, and fastener openings 94 through which fasteners 80 extend. These openings permit the appropriate access of the other elements of inner lock portion 12 while enabling a substantially rigid connection with door 16 to be formed. This rigid connection provides a rigid connection between the fastening elements 84 of the plate 22 and the door 16. Thus, when the housing 24 is attached to fastening elements 84, housing 24 becomes substantially rigidly attached to door 16.

Fastening elements 84 may take various forms to provide the basic function of providing a releasable attachment for the indicator assembly housing. As illustrated, the fastening elements 84 are formed as L-shaped extensions having a spaced projection 96 configured to mate with a corresponding fastening member attached to trim housing 24. Projections 96 are configured to mate with trim housing 24 in a rotatable manner. That is, projections 96 are oriented to receive trim housing 24 as the perimeter wall 102 of trim housing 24 is rotated clockwise. Of course other forms of projections 96 may be used; such as, connections oriented to receive trim housing 24 in a counter-clockwise direction, or bayonet connections permitting trim housing 24 to be received axially without rotation. Plate 22 can be made of various materials; such as, metal.

The housing 24 provides a device for supporting the indicator assembly 30 and enabling it to be removably attached to lock mechanism 18 such that when the housing 24 is attached to the lock mechanism 18, the indicator assembly 30 can function to display the position of the lock mechanism 18. Then, when removed from the lock mechanism 18, the housing 24 permits the indicator assembly 30 to be accessed such that its elements, such as the power source 112 or the indicator 110 can be replaced or maintained. The housing 24 may also provide for a lock mechanism activating device, such as lock portion 26, to manipulate the lock mechanism 18 between the locked and unlocked positions. Housing 24 may also be provided in a compact configuration to improve aesthetics.

Housing 24 can take various forms and configurations. In the embodiment of FIGS. 1-10, housing 24 is illustrated as a trim housing 24 for a lock portion 26. In particular, as seen in FIGS. 1-10, trim housing 24 includes a base 100 surrounded by a perimeter wall 102. As illustrated, perimeter wall 102 includes fastening members 104 for mating with fastening elements 84 projecting from plate 22. Fastening members 104 can take any appropriate configuration to mate with elements 84, such as the form of flanges inwardly spaced from perimeter wall 102 to receive a corresponding projection 96 from plate 22 as the housing 24 is rotated in a clockwise direction as illustrated in FIG. 5. Fastening members 104 are also constructed to permit their removal from fastening elements 84 from their corresponding fastening element 84 on plate 22 as, for instance, with a counterclockwise rotation of trim housing 24. As seen in FIGS. 3-5 and 10, perimeter wall 102 is constructed to move relative to base 100 so that the fastening members 104 can be moved into and out of engagement with fastening elements 84, while permitting the power source 112 and indicator 110 to remain stationary. Base 11 encloses the face of trim housing 24 and provides support for the indicator assembly 30.

The indicator assembly 30 senses the position on the lock mechanism 18 and provides an indication to the user of that position. In the instance of a door lock as illustrated herein, the indicator assembly 30 provides an indication of whether the door lock is in the open position or the closed position. Various indicator assemblies may be employed to carry out this function. As seen in FIGS. 1-10, the indicator assembly 30 of the illustrated embodiment includes an illuminating indicator 110, a battery power source 112, a printed circuit board 116, and a power source support structure 118. However, the indicator assembly 30 can be structure differently. For instance, if a mechanically powered indicator is employed, an indicating assembly may be used that does not require a power source 112, its corresponding support structure 118, or the integrated circuit board 116.

In the illustrated embodiment of FIGS. 1-10, the indicator 110 is shown as a light, such as an light emitting diode or LED that is electronically coupled to PCB 116 in a known manner and extends through an opening 126 in base 100. Although various lights and LED can be used if a light indicator is used, one example of an LED is a 3 mm red LED. The LED is preferably arranged so that it can be seen in daylight from a distance of six meters. The light 110 is powered by power source 112, which is illustrated as a replaceable or rechargeable battery, although various power sources could be employed. Among replaceable or rechargeable batteries, again, various ones may be used. One particular battery that may be used is a replaceable battery providing extended life to decrease the frequency of replacing the batteries 110. For example, a preferred minimum life of the batteries 110 may be 6570 hours of life, which would provide illumination of light 110 for eighteen hours a day for 365 days. Although a pair of batteries 110 is illustrated, a single battery or more than two batteries may be used. If a pair of batteries is used, a battery life commensurate with the preferred minimum power source life can be accomplished by two 1.5 volt AAA alkaline batteries.

In the illustrated embodiment, the batteries 112 are attached to the base 100 of trim housing 24 by support structure 118, which provides a cradle for securely receiving the batteries 112, while permitting the batteries 112 to be removed and replaced. The support structure 118 may provide this function through resilient keepers 122. The support structure 118 would necessarily have the appropriate electrical connections and be electronically connected to the circuit board 116 and light 110 in a conventional manner.

The support structure 118 may contribute to making the trim housing 24 more compact by it being oriented to that the power source 112 such that it is positioned within the opening 89 in door 16. As seen in FIG. 10, the power source 112 extends through power source opening 90 and into door opening 89. Of course, if the power source 112 was sufficiently small, it could merely be attached to the PCB 116 without an elaborate supporting structure or the need for it to be inserted through an opening in plate 22 and inserted into opening 89.

The indicator 110 and battery 112 are electronically coupled to PCB 116 in a conventional manner. PCB 116, as illustrated, is secured within trim housing 24 and has a switch 124, which is positioned so that it can be activated by the movement of the lock portion 26. Switch 123 can be a conventional switch and be electronically arranged in a conventional manner so that the movement of switch 124 by lock portion 26 will either activate or deactivate indicator 110 to indicate to the user the position of the lock portion 26, which is, in turn, indicating the position of lock mechanism 18. The PCB 116 can include other features as well, such as a flashing element to permit the light 110 to flash as opposed to providing no illumination or to being constantly illuminated. For example, the indicator 110 can be pulsed repeatedly. A preferred maximum rate of pulsing is every three seconds.

Preferably, the PCB 116 is coated to protect it against condensation and humidity such that it can pass a twenty-four hour salt spray test. Additionally, the circuit and battery are preferably protected from reverse polarity. Also, switch 124 is preferably formed of durable construction to decrease maintenance on the switch. For example, switch 124 preferably has a minimum cycle life of 200,000 mechanical cycles. Further, the entire indicating assembly should preferably be constructed and protected in conventional ways for a wide range of operating temperatures, such as, between 110 degrees F. (43 degrees C.) to −15 degrees F. (−26 degrees C.).

Lock portion 26 provides a mechanism by which a user can manipulate lock mechanism 18. The indicator assembly 30 monitors the manipulation of lock mechanism 18 to signal to the user the position of the lock mechanism 16. The manipulation of lock mechanism 18 and, thus, the structure of lock portion 26 can take various forms. In FIGS. 1-10, the lock portion is illustrated as a “thumb-turn” knob 150 having a shaft 152 that is coupled to lock mechanism 18. However, other lock portion 26 arrangements are possible. For example, lock portion 26 can be a key-receiving device so that the lock portion 26 and, thus, the lock mechanism 18 can not be activated directly by a user's hand, but must be activated by a key. Additionally, although a “thumb-turn” knob 150 is illustrated, other hand-activated devices can also be employed.

In the embodiment illustrated in FIGS. 1-10, shaft 152 has an opening 156 for receiving a turning rod 140 of lock mechanism 18. Thus, when the knob 150 and shaft 152 are turned, the rod 140 will turn to activate lock mechanism 18 and move bolt 20 between its extended position and its retracted position as seen in FIG. 1. Of course, various other couplings between knob 150 and lock mechanism 18 and between shaft 152 and rod 140 may be employed.

So that the rotation of shaft 152 can be monitored by the indicating assembly, shaft 152 may be provided with a cam 154 as best seen in FIGS. 9 and 10. The cam 154 is rigidly attached to shaft 152 so that it rotates along with shaft 152. Cam 154 is configured and sized to activate switch 124 on PCB 116. For example, cam 145 may have a protrusion 158 that comes into contact with switch 124 as it shaft 152 is rotated and as protrusion passes by switch 124.

Therefore, FIGS. 1-10 illustrate an embodiment of the invention in which an indicator 110 and a power source 112 are coupled to a trim housing 24 to provide a compact assembly that can be removed from the door 16, have its power source 112 replaced or be otherwise maintained, and then be reattached to door 16.

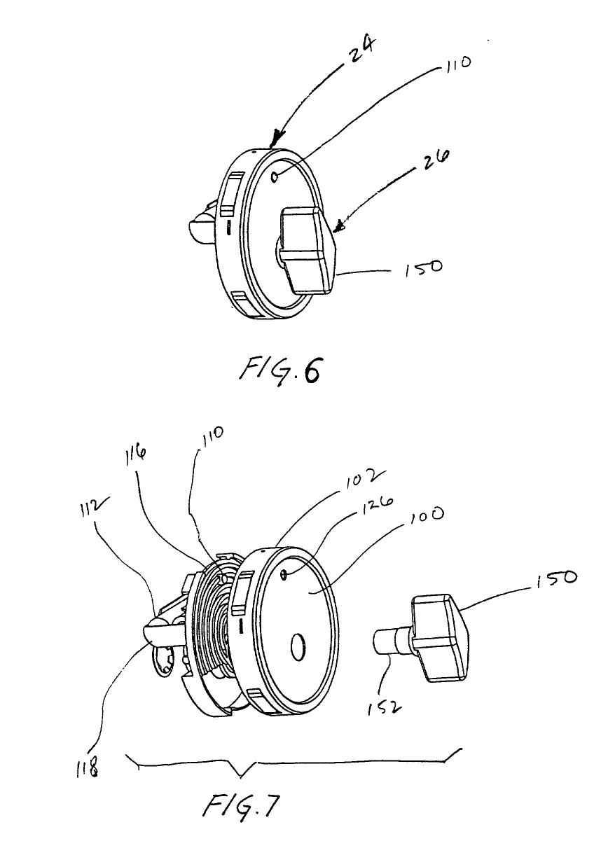

As seen in FIGS. 3-5, the trim housing 24 with indicator assembly 30 and lock portion 26 attached, can form a single device that can be brought into engagement with the door 16 and with mounting structure 22 so that the power source 112 is inserted into power source opening 90 in plate 22 and within door opening 89, as seen in FIG. 10. Then, the perimeter wall 102 of housing 24 can be turned clockwise, as illustrated, relative to the plate 22 and relative to indicator assembly 30 and lock portion 26 to engage the fastening members 104 of perimeter wall 102 with the fastening elements 84 of mounting structure or plate 22. When it is desired to remove housing 24 from door 16, the perimeter wall 102 can be turned in the counterclockwise direction, opposite to that shown in FIG. 5 so that the fastening members 104 disengage from the fastening elements 84. Then, the housing 24 can be removed from the door in a direction opposite to that shown in FIGS. 3 and 4, permitting access to the indicator assembly 30 or to the lock mechanism 18. Additionally, the removal of housing 24 could be provided for other reasons, such as, changing the housing 24 to one with a key receiving slot and without a knob 150.

A further embodiment of the invention is illustrated in FIG. 11 as door lock assembly 210. Door lock assembly 210 is substantially identical to the embodiment disclosed and illustrated with respect to FIGS. 1-10 except that the orientation of the inner and outer lock sections 12 and 14 is changed with respect to their position on a door. In particular, whereas, FIGS. 1-10 illustrate inner and outer lock sections 12 and 14 arranged on one side of door 16, FIG. 11 illustrates inner and outer lock sections 12 and 14 arranged on an opposite side of a door 116.

While the invention has been described with reference to the certain illustrated embodiments, the words, which have been used herein, are words of description, rather than words or limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

What is claimed is:

1. A door lock assembly comprising:
a lock mechanism configured and arranged to be positioned within a door for locking and unlocking the door;
a trim housing constructed and arranged to be releasably and fixedly secured to the door;
a lock portion extending through said trim housing and coupled to said lock mechanism to change the lock mechanism between a locked position and an unlocked position;
an indicator affixed to said trim housing;
a power source affixed to said trim housing to be releasably and fixedly secured to the door along with said trim housing; and
a switch coupled to at least one of said lock mechanism and said lock portion, said switch also being electrically coupled to said power source and to said indicator, said switch being constructed and arranged to selectively activate said indicator to display to a user whether the door is locked or unlocked depending on the position of said at least one of said lock mechanism and said lock portion.

2. A door lock assembly according to claim 1, wherein said lock portion includes a knob, which is turnable by hand.

3. A door lock assembly according to claim 1, further comprising:
a support structure affixed to said trim housing for removably securing said power source to said trim housing.

4. A door lock assembly according to claim 1, wherein said trim housing includes an perimeter wall configured to abut the door.

5. A door lock assembly according to claim 1, wherein said indicator includes a light

6. A door lock assembly according to claim 5, wherein said light is a light emitting diode.

7. A door lock assembly according to claim 1, wherein said power source includes a battery.

8. A door lock assembly according to claim 1, wherein said switch is mechanically attached directly to said lock portion.

9. A door lock assembly according to claim 8, wherein said lock portion includes a cam to activate said switch.

10. A door lock assembly according to claim 1, wherein said trim housing is constructed and managed to be releasably and fixedly mounted to the door by being releasably and fixedly mounted to a mounting structure, said mounting structure being constructed and arranged to be fixedly secured to the door.

11. A door lock assembly according to claim 10, wherein
at least one of said trim housing and said mounting structure includes an projection for interlocking with the other of said trim housing and said mounting structure such that said trim housing can be moved between a fixed position and a released position with respect to said mounting structure by turning said trim housing relative to said mounting structure.

12. A door lock assembly according to claim 1, further comprising:
a flashing element coupled to said indicator such that said indicator can flash to display to a user the position of the lock mechanism.

13. A door and lock assembly comprising:
a lock mechanism positioned within a door for locking and unlocking said door;
a trim housing releasably and fixedly secured to an outer surface of said door such that said trim housing is positioned outside said door adjacent said outer surface of said door;
a lock portion extending through said trim housing and coupled to said lock mechanism to change said lock mechanism between a locked position and an unlocked position;
an indicator affixed to said trim housing;
a power source affixed to said trim housing to be releasably and fixedly secured to said door along with said trim housing; and
a switch coupled to at least one of said lock mechanism and said lock portion, said switch also being electrically coupled to said power source and to said indicator, said switch being constructed and arranged to selectively activate said indicator to display to a user whether said door is locked or unlocked depending on the position of said at least one of said lock mechanism and said lock portion.

14. A door and lock assembly according to claim 13, wherein said lock portion includes a knob, which is turnable by hand.

15. A door and lock assembly according to claim 13, wherein said lock mechanism includes a locking bolt movable into and out of said door, while said trim housing remains stationary relative to said door.

16. A door and lock assembly according to claim 13, wherein said trim housing includes a perimeter wall abutting said outer surface of said door.

17. A door and lock assembly according to claim 13, wherein said power source includes a battery.

18. A door and lock assembly according to claim 17, wherein said battery extends within an opening in said door.

19. A door and lock assembly according to claim 13, wherein said trim housing is releasably and fixedly mounted to said door by being releasably and fixedly mounted to a mounting structure, said mounting structure being fixedly secured to said outside surface of said door.

20. A door lock assembly comprising:
a lock mechanism configured and arranged to be positioned within a door for locking and unlocking the door;
a mounting structure constructed and arranged to be fixedly secured to the door, said mounting structure having a first fastening element;
a trim housing releasably and fixedly secured to said mounting structure, said trim housing having second fastening element releasably secured to said first fastening element such that said trim housing can be moved in a first direction relative to said mounting structure to fixedly secure said trim housing to said mounting structure and said trim housing can be moved in a second direction relative to said mounting structure to release said trim housing from said mounting structure;
a lock portion extending through said trim housing and configured and arranged to be coupled to said lock mechanism to change said lock mechanism between a locked position and an unlocked position; and
an indicator assembly coupled to said trim housing to display to a user whether the door is locked or unlocked.

21. A door lock assembly according to claim 20, wherein said indicator assembly includes an indicator and a power source for activating said indicator.

22. A door lock assembly according to claim 21, wherein said indicator assembly includes a switch coupled to said lock portion, said switch also being electrically coupled to said power source and to said indicator, said switch being constructed and arranged to selectively activate said indicator depending on the position of said at least one of said lock mechanism and said lock portion.

23. A door and lock assembly comprising:
a lock mechanism positioned within a door for locking and unlocking said door;
a mounting structure fixedly secured to said door, said mounting structure having a first fastening element;
a trim housing releasably and fixedly secured to said mounting structure, said trim housing having second fastening element releasably secured to said first fastening element such that said trim housing can be moved in a first direction relative to said mounting structure to fixedly secure said trim housing to said mounting structure and said trim housing can be moved in a second direction relative to said mounting structure to release said trim housing from said mounting structure;
a lock portion extending through said trim housing and coupled to said lock mechanism to change said lock mechanism between a locked position and an unlocked position; and
an indicator assembly coupled to said trim housing to display to a user whether said door is locked or unlocked.

24. A door lock assembly according to claim 23, wherein said indicator assembly includes an indicator and a power source for activating said indicator.

25. A door lock assembly according to claim 24, wherein said indicator assembly includes a switch coupled to said lock portion, said switch also being electrically coupled to said power source and to said indicator, said switch being constructed and arranged to selectively activate said indicator depending on the position of said at least one of said lock mechanism and said lock portion.

26. A method of replacing a power source in a door lock, comprising:
providing a door lock attached to a door and the door lock having a removable portion, the removable portion having a first removable element;
removing the removable portion from the door without the use of tools;
removing the first removable element from the removable portion;
attaching a second removable element to the removable portion; and
reattaching the removable portion to the door without the use of tools.

27. The method of claim 26, wherein the removing the first removable element from the removable portion includes removing a battery from the removable portion without the use of tools.
